(19) United States
(12) Patent Application Publication
(10) Pub. No.: US 2025/0191254 A1
(43) Pub. Date: Jun. 12, 2025

(54) LINE EFFECT PROCESSING METHOD AND APPARATUS, ELECTRONIC DEVICE, STORAGE MEDIUM AND PRODUCT

(71) Applicant: Lemon Inc., Grand Cayman (KY)

(72) Inventors: Mingfei Wu, Beijing (CN); Yunzhu Li, Los Angeles, CA (US)

(21) Appl. No.: 18/844,909

(22) PCT Filed: Mar. 3, 2023
(86) PCT No.: PCT/SG2023/050130

§ 371 Date: Sep. 6, 2024

(30) Foreign Application Priority Data
Mar. 8, 2022 (CN) 202210220029.5

(51) Int. Cl. G06T 11/20; G06T 5/70; G06T 7/13; G06T 11/00; G06V 10/46

(52) U.S. Cl. CPC G06T 11/203; G06T 5/70; G06T 7/13; G06T 11/001; G06V 10/46; G06T 2207/20164

(57) ABSTRACT

Embodiments of the disclosure provide a line effect processing method and apparatus, an electronic device, a storage medium, a computer program product, and a computer program. The method includes: collecting a plurality of contour points formed by an object contour of a target object in an image to be processed; performing point expansion processing on the plurality of contour points to obtain a plurality of vertices; generating, based on the plurality of vertices, texture curves corresponding to adjacent pairs of vertices, and obtaining at least one texture curve; utilizing the at least one texture curve to generate an effect line frame; and mapping the effect line frame onto the image to be processed to obtain a target image corresponding to the image to be processed. Problems of missed gaps in line effect displaying are solved, and smooth display accuracy of a line effect is improved.

### CROSS REFERENCE TO RELATED APPLICATIONS

This disclosure is the U.S. National Stage of International Application No. PCT/SG2023/050130, filed on Mar. 3, 2023, which claims priority to Chinese Patent Application No. 202210220029.5, filed on Mar. 8, 2022, in the Chinese Intellectual Property Office and entitled “LINE EFFECT PROCESSING METHOD AND APPARATUS, ELECTRONIC DEVICE, STORAGE MEDIUM AND PRODUCT”, the disclosure of which is incorporated by reference herein in its entirety.

### FIELD

Embodiments of the present disclosure relate to the field of computer technologies, and in particular, to a line effect processing method and apparatus, an electronic device, a storage medium, a computer program product, and a computer program.

### BACKGROUND

With the rapid development of live broadcast and short video fields, video effects are more widely applied. Particularly, constructing a line effect based on human body feature points is a common rendering technology. A relatively common technology is to dynamically construct a suitable strip model through the human body feature points, and obtain effect lines after the width and curve of a strip are set smoothly. However, the line effects obtained in this manner have problems such as a missed gap and line unsmoothness or the like at transition positions, resulting in low accuracy of the line effects and poor display effect.

### SUMMARY

Embodiments of the present disclosure provide a line effect processing method and apparatus, an electronic device, a storage medium, a computer program product, and a computer program, to overcome the technical problems of low accuracy of line effects and poor display effect due to the existence of a missed gap, line unsmoothness, and the like at transition positions.

In a first aspect, an embodiment of the present disclosure provides a line effect processing method, comprising:
collecting a plurality of contour points formed by an object contour of a target object in an image to be processed;
performing point expansion processing on the plurality of contour points to obtain a plurality of vertices;
generating at least one texture curve based on adjacent pairs of vertices in the plurality of vertices;
utilizing the at least one texture curve to generate an effect line frame; and
mapping the effect line frame onto the image to be processed to obtain a target image corresponding to the image to be processed.

In a second aspect, an embodiment of the present disclosure provides a line effect processing apparatus, comprising:
a contour collection unit for collecting a plurality of contour points formed by an object contour of a target object in an image to be processed;
a vertex expansion unit for performing point expansion processing on the plurality of contour points to obtain a plurality of vertices;
a curve generation unit for generating at least one texture curve based on adjacent pairs of vertices in the plurality of vertices;
an effect generation unit for utilizing the at least one texture curve to generate an effect line frame; and
a line mapping unit for mapping the effect line frame onto the image to be processed to obtain a target image corresponding to the image to be processed.

In a third aspect, an embodiment of the present disclosure provides an electronic device, including:
a processor; and
a memory,
the memory stores computer executable instructions,
the processor executes the computer-executable instructions stored in the memory, so that the at least one processor performs the line effect processing method of the first aspect.

In a fourth aspect, an embodiment of the present disclosure provides a computer-readable storage medium having stored therein computer executable instructions, that when executed by a processor, implement the line effect processing method of the first aspect. In a fifth aspect, an embodiment of the present disclosure provides a computer program product including a computer program, that when executed by a processor, implements the line effect processing method of the first aspect.

In a sixth aspect, an embodiment of the present disclosure further provides a computer program, that when executed by a processor, implements the line effect processing method of the first aspect.

### BRIEF DESCRIPTION OF THE DRAWINGS

To more clearly explain the technical solutions in the embodiments of the present disclosure or in the prior art, the accompanying drawings needed to be used in the description of the embodiments or the prior art will be briefly introduced below. It is apparent that the accompanying drawings in the following description are some embodiments of the present disclosure. To those of ordinary skill in the art, other drawings may also be obtained according to these drawings without creative efforts.

FIG. 1 is a system architecture diagram of a line effect processing method according to an embodiment of the present disclosure;

FIG. 2 is a flowchart of a line effect processing method according to an embodiment of the present disclosure;

FIG. 3 is an example diagram of a contour point expansion according to an embodiment of the present disclosure;

FIG. 4 is another flowchart of a line effect processing method according to an embodiment of the present disclosure;

FIG. 5 is another flowchart of a line effect processing method according to an embodiment of the present disclosure;

FIG. 6 is a schematic structural view of a line effect processing apparatus according to an embodiment of the present disclosure; and

FIG. 7 is a schematic diagram of a hardware structure of an electronic device according to an embodiment of the present disclosure.

### DETAILED DESCRIPTION

In order to make objects, technical solutions and advantages of the embodiments of the present disclosure more apparent, the technical solutions in the embodiments of the present disclosure will be clearly and fully described below in conjunction with the drawings related to the embodiments of the present disclosure. Obviously, the described embodiments are only a part but not all of the embodiments of the present disclosure. All other embodiments obtained by those of ordinary skill in the art based on the embodiments of the present disclosure without creative efforts shall belong to the scope of protection of the present disclosure.

The technical solutions of the present disclosure can be applied to a scenario of video playing, and the video can comprise, for example, a type of video such as a live video, a short video, an audiovisual video and so on. By performing contour point detection and expansion on images in the video, a plurality of vertices with a wider coverage area can be obtained, so that more vertices are utilized to generate a texture curve, and the texture curve is utilized to generate a more accurate effect line frame, thereby achieving continuous and smooth display of effect lines, and improving the display accuracy and effect of the effect lines.

In the related art, an effect line is usually constructed on the basis of human body feature points. Generally, a strip model can be constructed directly on the detected human body feature points, and the effect line can be obtained after width and curve smoothing are performed on the strip model. However, in the manner of directly using the human body feature points to construct the strip model, the obtained line effects have problems such as many missed gaps and line unsmoothnesss at transition positions. As a result, the accuracy of the line effects is not high and the display effect is poor.

In order to solve the above-described technical problem, the inventors consider performing vertex expansion on the collected feature points to obtain more vertices. By means of the more vertices, a line expansion can be realized, and by means of the line expansion, an effect line well-matching an object contour can be obtained, thereby improving the precision and accuracy of the effect line.

In the embodiments of the present disclosure, after a plurality of contour points formed by an object contour of a target object in an image to be processed are collected, point expansion processing may be performed on the plurality of contour points to obtain a plurality of vertices. The plurality of vertices are a basis for constructing an effect line. The plurality of vertices are utilized to generate texture curves corresponding to adjacent pairs of vertices to obtain at least one curve. The at least one curve may be at least one curve surrounding the object contour of the target object. Based on the at least one texture curve, an effect line frame may be generated, thereby implementing accurate generation of the effect line frame of the object contour. After the effect line frame is obtained, the effect line frame can be mapped onto the image to be processed, and a target image corresponding to the image to be processed is obtained, thereby realizing an effective and accurate setting of the effect line of the image to be processed, and improving the setting accuracy of a line effect.

The technical solutions of the present disclosure and how to solve the above-described technical problem will be explained in detail below with reference to specific embodiments. The following several specific embodiments may be combined with each other, and the same or similar concepts or processes may not be repeated in certain embodiments. The embodiments of the present disclosure will be described in detail below in conjunction with the accompanying drawings.

According to the line effect processing method provided in this embodiment, after a plurality of contour points formed by an object contour of a target object in an image to be processed are collected, point expansion processing may be performed on the plurality of contour points to obtain a plurality of vertices. The plurality of vertices are a basis for constructing an effect line. The plurality of vertices are utilized to generate texture curves corresponding to adjacent pairs of vertices to obtain at least one curve. The at least one curve may be at least one curve surrounding the object contour of the target object. Based on the at least one texture curve, an effect line frame may be generated, thereby implementing accurate generation of the effect line frame of the object contour. After the effect line frame is obtained, the effect line frame can be mapped onto the image to be processed, and a target image corresponding to the image to be processed is obtained, thereby realizing an effective and accurate setting of the effect line of the image to be processed, and improving the setting accuracy of a line effect.

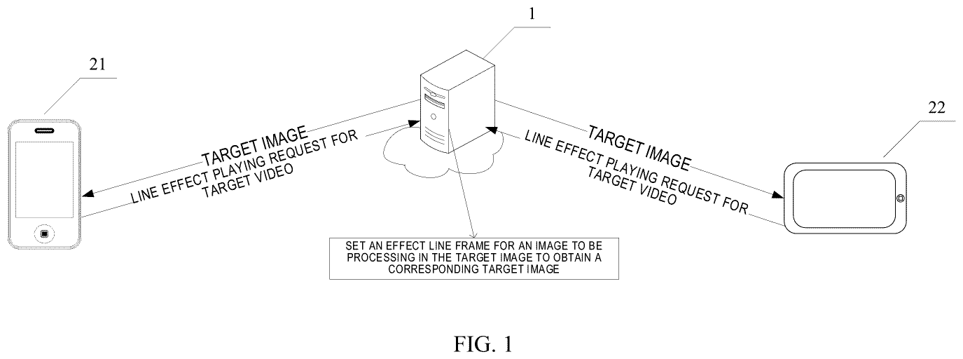

FIG. 1 is a network architecture diagram of a line effect processing method according to the present disclosure. An application network architecture according to an embodiment of the present disclosure may include an electronic device and a client that is connected to the electronic device through a local area network (LAN) or a wide area network (WAN). It is assumed that the electronic device may be a type of server such as a personal computer, a common server, a super personal computer, a cloud server and so on, and the present disclosure does not limit the specific type of the electronic device. The client may be, for example, a terminal device such as a mobile phone, a tablet computer, a personal computer, a smart appliance, a wearable device and so on, and the present disclosure does not limit the specific type of the client. As shown in FIG. 1, by taking the electronic device being a cloud server 1 and a user equipment 2 being a mobile phone 21 or a tablet computer 22 as an example, any user equipment may initiate a line effect playing request to the cloud server 1. The cloud server 1 may acquire a target video sent by the user equipment, collect an image to be processed from the target video, obtain a corresponding target image after an effect line frame setting is performed on the image to be processed according to the technical solution, and render and display the target image in the user equipment 2 after being sent to the user equipment 2.

Of course, the example shown in FIG. 1 shows that the electronic device 1 and the user equipment 2 are different devices, but in an actual application, the electronic device 1 and the user equipment 2 may be the same device, for example, both may be mobile phones. The technical solution may be configured in the mobile phones to directly perform effect line setting for a played video.

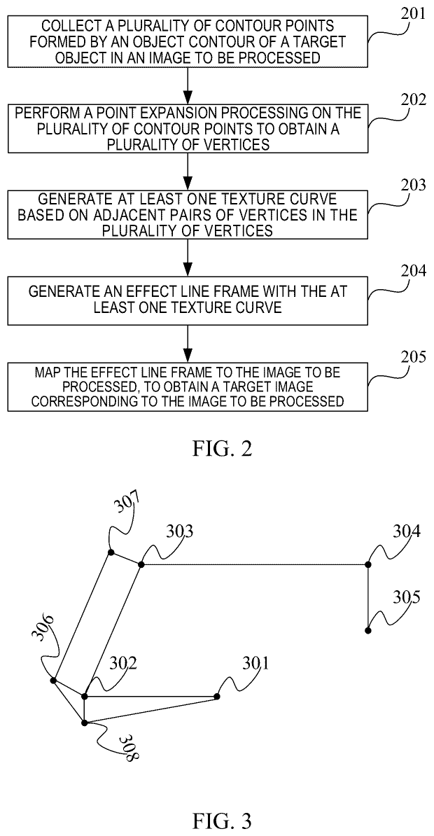

Referring to FIG. 2, which is a flowchart of one embodiment of an effect line processing method according to an embodiment of the present disclosure. The method may comprise the following several steps:

201: Collect a plurality of contour points formed by an object contour of a target object in an image to be processed.

Optionally, the image to be processed may be an image collected from a video. The video may comprise a type of video such as a live video, a short video and so on. The target object may refer to a type of object such as a person, a scene, an article, or a vehicle in the image to be processed, particularly a human face. The object contour may refer to an edge line formed by a shape range of the target object, particularly a contour of the human face, a contour of facial features, or the like in the image. The plurality of contour points may refer to key points formed when the object contour is formed. The plurality of contour points may be connected to form the object contour.

In this example, when the target object refers to the human face or facial features, the step used to collect a plurality of contour points formed by an object contour of a target object in an image to be collected may comprise: recognizing, based on a human body key boundary recognition algorithm, the plurality of contour points forming the object contour of the target object from the image to be collected. A skeleton positioning & tracking algorithm may also be used to recognize the plurality of contour points forming the object contour of the target object from the image to be collected.

202: Perform point expansion processing on the plurality of contour points to obtain a plurality of vertices.

The plurality of vertices may be obtained by contour point expansion processing. One contour point may expand one or more vertices.

203: Generate at least one texture curve based on adjacent pairs of vertices in the plurality of vertices.

The texture curve may be obtained by connecting the adjacent pairs of vertices. A line segment may be obtained by connecting the adjacent pairs of vertices, and a plurality of line segments may be obtained by connecting the adjacent pairs of vertices among the plurality of vertices. After line segment connection and smooth processing is performed on two line segments, a texture curve may be obtained. After the line segment connection and smooth processing is performed on adjacent pairs of line segments among the plurality of line segments, at least one texture curve may be obtained.

The texture curve may be provided with a curve color and a curve attribute of a light ray, and has a certain texture.

204: Utilize the at least one texture curve to generate an effect line frame.

The effect line frame may be generated by the at least one texture curve. The at least one texture curve may be gap-processed to obtain a continuous curve, and the continuous curve is smoothed to obtain a smooth curve. The smooth curve is mapped into a line frame model, so that a curve line frame may be obtained. After effect setting is performed on the curve line frame, the effect line frame may be obtained.

205: Map the effect line frame onto the image to be processed to obtain a target image corresponding to the image to be processed.

Optionally, the step used to map the effect line frame onto the image to be processed to obtain a target image corresponding to the image to be processed may comprise: mapping the effect line frame to the object contour of the target object in the image to be processed; and matching the effect line frame with the object contour to obtain the target image corresponding to the image to be processed.

In the embodiments of the present disclosure, after a plurality of contour points formed by an object contour of a target object in an image to be processed are collected, point expansion processing may be performed on the plurality of contour points to obtain a plurality of vertices. The plurality of vertices are a basis for constructing an effect line. The plurality of vertices are utilized to generate texture curves corresponding to adjacent pairs of vertices to obtain at least one curve. The at least one curve may be at least one curve surrounding the object contour of the target object. Based on the at least one texture curve, an effect line frame may be generated, thereby implementing accurate generation of the effect line frame of the object contour. After the effect line frame is obtained, the effect line frame can be mapped onto the image to be processed, and a target image corresponding to the image to be processed is obtained, thereby realizing an effective and accurate setting of the effect line of the image to be processed, and improving the setting accuracy of a line effect.

As an embodiment, the performing point expansion processing on the plurality of contour points to obtain a plurality of vertices may comprise:
connecting two contour points satisfying adjacent conditions among the plurality of contour points to obtain at least one contour line segment;
determining, based on a line width, an expansion line segment corresponding to a contour line segment, to obtain expansion line segments corresponding to the at least one contour line segment;
determining, by utilizing the expansion line segments corresponding to the at least one contour line segment, that two end points of the expansion line segment are two expansion points, to obtain a plurality of expansion points formed by expansion points of the at least one expansion line segment; and
de-duplicating the plurality of contour points and the plurality of expansion points to obtain the plurality of vertices.

The plurality of vertices may be obtained by performing point expansion processing on the plurality of contour points. A point set corresponding to the plurality of vertices may realize a plurality of line segments. The plurality of line segments may include at least one contour line segment and an expansion line segment corresponding to the at least one contour line segment.

The line width may be obtained by setting, and a width of the contour line segment is expanded based on the line width, so that a width of the effect line satisfies the requirements of the effect line.

In the embodiments of the present disclosure, when point expansion processing is performed on the plurality of contour points, two points satisfying adjacent conditions among the plurality of contour points may be connected first, and a contour of the target object may be accurately connected by connecting contour points, to obtain at least one contour line segment. Based on the line width, an expansion line segment corresponding to the contour line segment may be determined, and expansion line segments corresponding to the at least one contour line segment are obtained. With the expansion line segments corresponding to the at least one contour line segment, it can be determined that two end points of the expansion line segment are two expanded points. A line segment expansion of the effect line is realized by taking the contour line segment as an expansion basis. By means of the line segment expansion of the effect line, an expansion point well-matching the effect line can be obtained, and the points related to the effect line can be expanded accurately, thereby improving the expansion precision and accuracy.

In a possible design, the determining, based on a line width, an expansion line segment corresponding to a contour line segment may comprise:
detecting whether two vertices corresponding to the contour line segment include a tail point;
making a vertical line perpendicular to the contour line segment to a non-tail point of the two vertices according to the line width in case that the tail point is included, and determining the other end point of the vertical line to be an expansion point corresponding to the contour line segment;
determining a line segment formed by connecting the expansion point with the tail point to be the expansion line segment corresponding to the contour line segment; and
making vertical lines perpendicular to the contour line segment according to the line width for two contour points of the contour line segment in case that no tail point is included, and determining a line segment formed by the other two end points corresponding to the two vertical lines to be the expansion line segment.

The tail point may refer to two end points of a contour. For ease of understanding, as shown in FIG. 3, a plurality of contour points shown in FIG. 3 may be identified as 301-305, where the contour point 301 and the contour point 305 may refer to tail points of the contour. The contour points 302-304 may be non-tail points of the contour.

When expanding a non-tail point, a vertical line can be directly made according to the line width to obtain a corresponding expansion point. And when expanding a tail point, an expansion point can be directly connected to a contour point to obtain a corresponding expansion line segment. Referring to FIG. 3, the other two end points 306 and 307 of the two vertical lines obtained by making a vertical line to line segments of the two non-tail points 302 and 303 are both expansion points, and the line segments obtained by connecting the two expansion points are the expansion line segments of the contour line segments of 302 and 303. With regard to having the tail point 301 and the non-tail point 302, by making a vertical line perpendicular to the contour line segment according to the line width based on the non-tail points, the other end point 308 of the vertical line is determined as an expansion point, and the tail point 301 and the expansion point 308 can be connected to form a corresponding expansion line segment. The expansion point 306 and the expansion point 308 are also two adjacent end points, and a corresponding expansion line segment may also be obtained by connecting 306 and 308. It should be noted that the expansion points 306-308 are shown in FIG. 3. Other expansion points are not shown. The expansion points shown in FIG. 3 are merely exemplary, and shall not constitute a specific limitation to the number and manner of expansion of contour points.

Of course, in certain embodiments, both the end point and the non-end point in the vertex may be perpendicular to each other directly according to the line width, and the other end of the vertical line is an expansion point. The two expansion points are connected to obtain an expansion line segment. Meanwhile, the tail point is connected to an expansion point of the tail point to obtain a corresponding expansion line segment.

In the embodiments of the present disclosure, it is detected whether two vertices corresponding to the contour line segment include a tail point, and if so, a vertical line may be made to a non-tail point of the two vertices according to the line width, to obtain the other end point of the vertical line as an expansion point of the contour line segment. A length of the vertical line is the line width. In a manner of the vertical line, translation of a contour point can be realized, and a line segment formed by connecting the obtained expansion point to the tail point is the expansion line segment of the contour line segment. In case that no tail point is included, a vertical line perpendicular to the contour line segment may be formed according to the line width for two contour points of the contour line segment, and a line segment formed by the other two end points corresponding to the two vertical lines is obtained as an expansion line segment. By detecting tail points of two vertices of the contour line segment, when a tail point exists in a line segment, a special line segment expansion of the tail point can be realized, and by utilizing a line segment connected between the tail point and another end point of a vertical line corresponding to the non-tail point as an expansion line segment, a targeted line segment expansion of the tail point can be realized. In case that no tail point is included, a corresponding expansion line segment may be obtained by direct translation, thereby expanding the width of the effect line. By detecting the tail point and the non-tail point, accurate expansion of the effect line can be realized, thereby improving the expansion efficiency and accuracy.

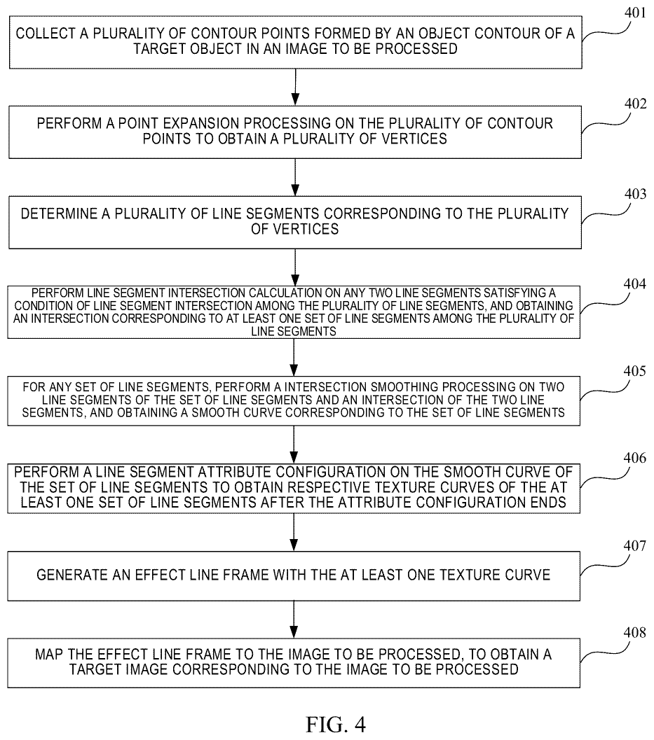

In order to obtain a smoother effect line, intersections between two line segments may be smoothed. FIG. 4 is a flowchart of another embodiment of an effect line processing method according to an embodiment of the present disclosure, and the method may comprise the following several steps:

401: Collect a plurality of contour points formed by an object contour of a target object in an image to be processed.

Some steps in this embodiment are the same as those in the foregoing embodiment, and are not described herein again for brevity of description.

402: Perform point expansion processing on the plurality of contour points to obtain a plurality of vertices.

403: Determine a plurality of line segments corresponding to the plurality of vertices.

Optionally, the plurality of line segments may include at least one contour line segment and at least one expansion line segment. The plurality of line segments corresponding to the plurality of vertices may also be obtained by obtaining a line segment by connecting two vertices satisfying a connection condition among the plurality of vertices. Furthermore, the plurality of line segments may further include line segments formed by connecting two adjacent expansion points. The plurality of line segments may be obtained by connecting adjacent pairs of vertices among the plurality of vertices.

404: Calculate line segment intersections for any two line segments satisfying a condition of line segment intersection among the plurality of line segments, and obtaining intersections corresponding to at least one line segment group among the plurality of line segments.

405: Perform, based on any line segment group, smooth processing on two line segments of the line segment group and intersections thereof, to obtain a smooth curve corresponding to the line segment group.

The smooth processing is performed at intersections between the two line segments, so that the two line segments and connecting lines thereof form a smooth curve, and a smooth curve of the line segment group is obtained.

Smooth curves corresponding to the at least one line segment group are obtained.

406: Perform line segment attribute setting on the smooth curve of the line segment group, to obtain respective texture curves of the at least one line segment group of which the attribute setting ends.

The step used to perform line segment attribute setting on the smooth curve of the line segment group, to obtain respective texture curves of the at least one line segment group of which the attribute setting ends may comprise: invoking a line position setting function to set a curve position of the smooth curve. The curve position can be represented by vertices in the curve. To facilitate accurate setting of the curve position, a Mesh (network) in the Unity (game engine) can be used to record the curve position. The mesh is a data structure of a grid, and can record information such as a vertex and a vertex index. Afterwards, a curve corner of the smooth curve can be set, and then the curve position, curve width and curve color can also be set. When the setting ends, a refresh mechanism can be triggered, and a refresh flag bit is modified to be a true value. After the setting ends, a step of generating a texture curve can be initiated, and specifically when it is detected that the refresh flag bit is a true value, a line construction interface can refresh input vertex data and vertex index data of the Mesh, wherein attributes such as a position, a color and a UV (horizontal and vertical axis coordinates of an image) of the vertex can be specifically refreshed, to complete the generation of the texture curve.

407: Utilize the at least one texture curve to generate an effect line frame.

408: Map the effect line frame onto the image to be processed to obtain a target image corresponding to the image to be processed.

In the embodiments of the present disclosure, by means of the intersection determination, a connection point between the two line segments can be smoothed to obtain a smooth curve corresponding to the two line segments, and the smooth curve can comprise two intersected line segments, thereby realizing smooth connection of the line segments. After line segment attribute setting is performed on the smooth curves corresponding to the at least one line segment group, at least one texture curve of which the attribute setting ends can be obtained. The at least one texture curve may be two line segments connected with the smooth curves, and for the connection between the line segments, after all line segment groups obtain the corresponding smooth curves, the preliminary connection of all line segments may be completed. After the line segment attribute setting is performing on the smooth curves of respective line segment group, a main line of the effect line can be obtained, and at least one obtained texture curve can be used to generate the effect line frame. By determining intersections for two connectable line segments, and then connecting the two line segments by means of a smooth curve, it is possible to make the curve of the line segments smoother to present a better display effect.

As an embodiment, the step used to perform line segment attribute setting on the smooth curve of the line segment group, to obtain respective texture curves of the at least one line segment group of which the attribute setting ends comprises:
setting a color attribute and/or a width attribute of the smooth curve of the line segment group, and obtaining respective texture curves of the at least one line segment group of which the attribute setting ends.

The texture curve may be a smooth curve for which the color attribute and/or the width attribute are set.

For setting of the color attribute and/or the width attribute for the curve, reference may be made to the description in the foregoing embodiment, and details are not repeatedly described herein.

In the embodiments of the present disclosure, by setting the color attribute and/or the width attribute for the smooth curve, the color or width of the smooth curve can be accurately set, and the color and the width of the obtained texture curve better match actual usage requirements, and the accurate setting of the texture curve can be completed.

In a possible design, the utilizing the at least one texture curve to generate an effect line frame may comprise:
mapping the at least one texture curve into a line frame model to obtain a curve line frame corresponding to the object contour; and
setting a rendering attribute for a line frame area corresponding to the curve line frame to obtain the effect line frame.

The line frame model may be a preset line frame control, and the at least one texture curve may be mapped into the line frame model. The at least one texture curve may be represented by information such as a vertex set and a vertex index that are defined by the Mesh. The rendering attribute may include a rendering attribute such as floodlighting implemented by utilizing an effect function, for example, a High-Dynamic Range (HDR) function and a full-screen floodlighting effect (BLOOM) function, to obtain the effect line frame.

In the embodiments of the present disclosure, the at least one texture curve can be mapped into the line frame model to obtain a curve line frame corresponding to the object contour. By setting a rendering attribute for a line frame area corresponding to the curve line frame, rendering setting for the curve line frame can be completed, and an effect line frame having rendering effects can be obtained, thereby completing effective acquisition of the rendered line.

In a possible design, the mapping the effect line frame onto the image to be processed to obtain a target image corresponding to the image to be processed may comprise:
determining image positions corresponding to the plurality of contour points in the image to be processed;
determining line frame positions corresponding to the plurality of contour points in the effect line frame;
performing position matching on the line frame positions and the image positions corresponding to the plurality of contour points, to obtain a position matching relationship of the plurality of contour points; and
mapping the effect line frame onto the image to be processed based on the position matching relationship of the plurality of contour points, to obtain the target image corresponding to the image to be processed when the mapping of the effect line frame ends.

The plurality of contour points may correspond to image positions in the image to be processed, and the plurality of contour points correspond to line frame positions in the effect line frame. The image position of any contour point in the image to be processed corresponds to a position of a line frame, and a position matching relationship corresponding to the contour point can be obtained, thereby realizing the matching of the position of the contour point. By means of the matching of the position of the contour point, the effect line frame can be mapped onto the image to be processed, and a target image corresponding to the image to be processed is obtained.

In the embodiments of the present disclosure, after image positions of the plurality of contour points in the image to be processed and line frame positions in the effect line frame are determined, the image positions of the contour points may be in one-to-one correspondence with the line frame positions, so that the effect line frame is mapped to corresponding image positions according to the line frame positions corresponding to the plurality of contour points, and a target image at the end of mapping is obtained. Through mapping between a position of an image and a position of a line frame, accurate mapping from the effect line frame to the image to be processed may be implemented, and an accurate target image may be obtained.

In a possible design, after obtaining a target image corresponding to the image to be processed when the mapping of the effect line frame ends, the method further comprises:
correcting a position of the effect line frame in the target image to obtain a corrected target image.

Optionally, the correcting a position of the effect line frame may comprise correcting a vertex position, a vertex angle, a vertex direction, a vertex normal and/or a vertex UVO-3 for a plurality of vertices corresponding to the effect line frame in an image. The UV0-3 may refer to coordinates of the image in horizontal and vertical directions of a display, and its value is between 0 and 3, that is, the Uth pixel/picture width in the horizontal direction, and the Vth pixel/picture height in the vertical direction.

In the embodiments of the present disclosure, after the effect line frame is mapped onto the image to be processed, position correction processing may be performed on the effect line frame in a target image, a position of the effect line frame may be matched with a more accurate position of the image, and the target image after the correction processing is more accurate.

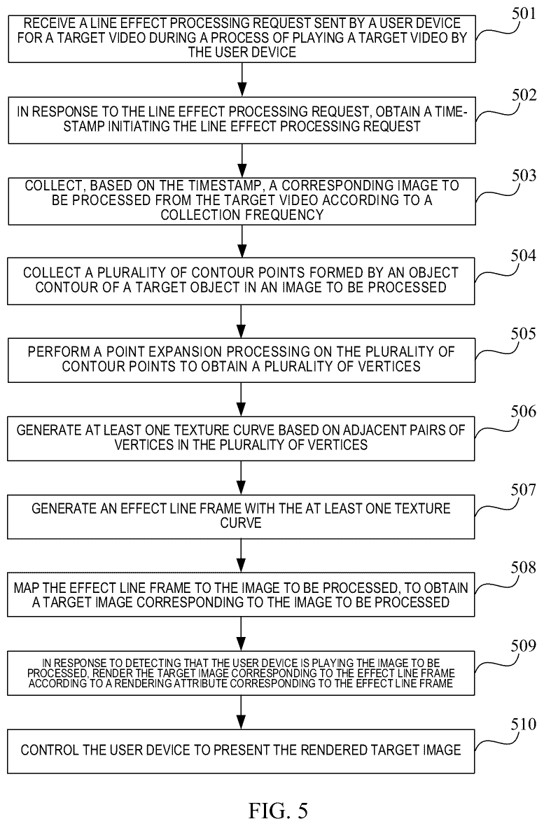

In an actual application, the image to be processed may be collected in a target video played by a user equipment. FIG. 5 is a flowchart of another embodiment of a line effect processing method according to an embodiment of the present disclosure. The method may include the following several steps:

501: Receive a line effect processing request sent by a user equipment for a target video in the process of playing the target video by the user equipment.

The user equipment may play the target video, where the target video may be a live video, and a line effect processing control may be set in a video player or a playback page. A user views the target video through a user equipment, and the user equipment may detect a line setting request set by the user for the line effect processing control. Through the line setting request, line effect processing on the target video may be started.

502: Acquire a time-stamp for initiating the line effect processing request, in response to the line effect processing request.

503: Collect, based on the time-stamp, a corresponding image to be processed from the target video according to a collection frequency.

The time-stamp may be obtained by reading time-stamps of the target video, and may also be obtained by reading from a system timer.

504: Collect a plurality of contour points formed by an object contour of a target object in an image to be processed.

505: Perform point expansion processing on the plurality of contour points to obtain a plurality of vertices.

506: Generate at least one texture curve based on adjacent pairs of vertices in the plurality of vertices.

507: Utilize the at least one texture curve to generate an effect line frame.

508: Map the effect line frame onto the image to be processed to obtain a target image corresponding to the image to be processed.

509: When it is detected that the user equipment is playing the image to be processed, render the target image corresponding to the effect line frame according to the rendering attribute corresponding to the effect line frame.

510: Control the user equipment to present the target image on which the rendering is completed.

The step used to control the user equipment to present the target image on which the rendering is completed may comprise sending a rendering instruction of the target image to the user equipment. After receiving the rendering instruction, the user equipment may perform rendering processing on the target image in response to the rendering instruction. The user equipment and the electronic device in the present disclosure may be the same device or different devices, and the embodiments of the present disclosure do not limit the manners of connection and construction of the user equipment and the electronic device. For example, the user equipment may be a mobile phone, and the electronic device may be a cloud server. However, the processing performance of the user equipment is relatively strong, and the technical solutions of the present disclosure may also be directly configured in the user equipment. For example, when the user equipment is a computer, the technical solutions of the present disclosure may be directly configured in the computer, and the specific rendering of the target image is executed by the computer.

Some steps in this embodiment are the same as those in the foregoing embodiment, and are not described herein again for brevity of description.

In the embodiments of the present disclosure, a line effect processing request sent by a user equipment for a target video may be received in the process of playing the target video by the user equipment. In response to the line effect processing request, a time-stamp for initiating the line effect processing request may be acquired, to collect, based on the time-stamp, a corresponding image to be processed from the target video according to a collection frequency. After setting an effect line for the image to be processed to obtain the target image, it can be detected that when the user equipment is playing a video to be processed, a target image corresponding to the effect line frame is rendered according to a rendering attribute corresponding to the effect line frame, to present the target image on which the rendering is completed. By detecting a line effect processing request of a user, a corresponding effect line may be set for the image to be processed in the target video, thereby realizing the accurate setting of an effect line, and improving the setting effect and accuracy of the effect line. By interacting with the user equipment, the display of the target image on which the rendering is completed is realized, the smoothness of the effect line is improved, and phenomenon such as a missed gap is avoided, thereby improving the display accuracy of the effect line.

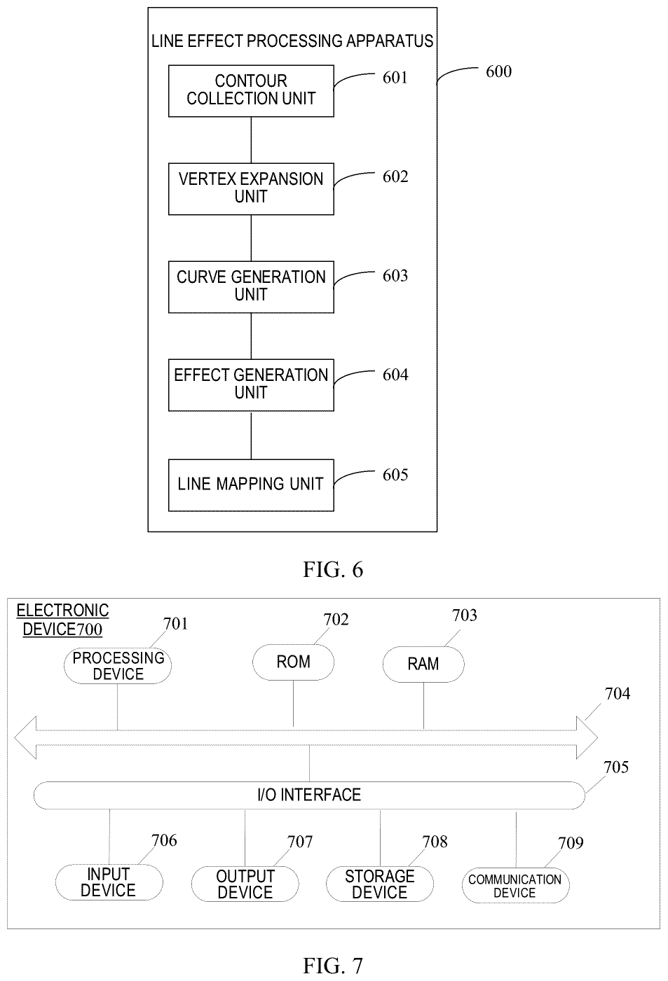

As shown in FIG. 6, which is a schematic structural diagram of one embodiment of a line effect processing apparatus according to an embodiment of the present disclosure, the line effect processing apparatus 600 may comprise the following serval units:
a contour collection unit 601 for collecting a plurality of contour points formed by an object contour of a target object in an image to be processed;
a vertex expansion unit 602 for performing point expansion processing on the plurality of contour points to obtain a plurality of vertices;
a curve generation unit 603 for generating at least one texture curve based on adjacent pairs of vertices in the plurality of vertices;
an effect generation unit 604 for utilizing the at least one texture curve to generate an effect line frame; and
a line mapping unit 605 for mapping the effect line frame onto the image to be processed to obtain a target image corresponding to the image to be processed.

In the embodiments of the present disclosure, after a plurality of contour points formed by an object contour of a target object in an image to be processed are collected, point expansion processing may be performed on the plurality of contour points to obtain a plurality of vertices. The plurality of vertices are a basis for constructing an effect line. The plurality of vertices are utilized to generate texture curves corresponding to adjacent pairs of vertices to obtain at least one curve. The at least one curve may be at least one curve surrounding the object contour of the target object. Based on the at least one texture curve, an effect line frame may be generated, thereby implementing accurate generation of the effect line frame of the object contour. After an effect line frame is obtained, the effect line frame can be mapped onto the image to be processed, and a target image corresponding to the image to be processed is obtained, thereby realizing an effective and accurate setting of the effect line of the image to be processed, and improving the setting accuracy of a line effect.

As an embodiment, the vertex extending unit comprises:
a line segment generation module for connecting two contour points satisfying adjacent conditions among the plurality of contour points to obtain at least one contour line segment;
a line segment expansion module for determining, based on a line width, an expansion line segment corresponding to a contour line segment, to obtain expansion line segments corresponding to the at least one contour line segment;
an end point determination module for determining, by utilizing the expansion line segments corresponding to the at least one contour line segment, that two end points of the expansion line segment are two expansion points, to obtain a plurality of expansion points formed by expansion points of the at least one expansion line segment; and
a vertex determination module for de-duplicating the plurality of contour points and the plurality of expansion points to obtain the plurality of vertices.

In a possible design, the line segment expansion module comprises:
a tail point detection subunit for detecting whether two vertices corresponding to the contour line segment include a tail point;
a first processing subunit for making a vertical line perpendicular to the contour line segment to a non-tail point of the two vertices according to the line width in case that the tail point is included, and determining the other end point of the vertical line to be an expansion point corresponding to the contour line segment; and
a second processing subunit for making vertical lines perpendicular to the contour line segment according to the line width for two contour points of the contour line segment in case that no tail point is included, and determining a line segment formed by the other two end points corresponding to the two vertical lines to be the expansion line segment.

As another embodiment, the curve generation unit comprises:
a line segment determination module for determining a plurality of line segments corresponding to the plurality of vertices;
an intersection determination module for calculating line segment intersections for any two line segments satisfying a condition of line segment intersection among the plurality of line segments, and obtaining intersections corresponding to at least one line segment group among the plurality of line segments;
a curve smoothing module for performing, based on any line segment group, smooth processing on two line segments of the line segment group and intersections thereof, to obtain a smooth curve corresponding to the line segment group; and
an attribute setting module for performing line segment attribute setting on the smooth curve of the line segment group, to obtain respective texture curves of the at least one line segment group of which the attribute setting ends.

In certain embodiments, the attribute setting module comprises:
an attribute setting submodule for setting a color attribute and/or a width attribute of the smooth curve of the line segment group, and obtaining respective texture curves of the at least one line segment group of which the attribute setting ends.

In a possible design, the effect generation unit comprises:
a line determination module for mapping the at least one texture curve into a line frame model to obtain a curve line frame corresponding to the object contour;
a rendering setting module for setting a rendering attribute for a line frame area corresponding to the curve line frame to obtain the effect line frame.

In a possible design, the line mapping unit comprises:
a first position module for determining image positions corresponding to the plurality of contour points in the image to be processed;
a second position module for determining line frame positions corresponding to the plurality of contour points in the effect line frame;
a position matching module for performing position matching on the line frame positions and the image positions corresponding to the plurality of contour points, to obtain a position matching relationship of the plurality of contour points; and
a position mapping module for mapping the effect line frame onto the image to be processed based on the position matching relationship of the plurality of contour points, to obtain the target image corresponding to the image to be processed when the mapping of the effect line frame ends.

In certain embodiments, the line mapping unit further comprises:
a position correction module for correcting a position of the effect line frame in the target image to obtain a corrected target image.

In a possible design, the apparatus further comprises:
a request receiving unit for receiving a line effect processing request sent by a user equipment for a target video in the process of playing the target video by the user equipment;
a request responding unit for acquiring a time-stamp for initiating the line effect processing request, in response to the line effect processing request;
an image acquisition unit for acquiring, based on the time-stamp, a corresponding image to be processed from the target video according to a collection frequency;
an image rendering unit for when it is detected that the user equipment is playing the image to be processed, rendering the target image corresponding to the effect line frame according to the rendering attribute corresponding to the effect line frame; and
an image display unit for controlling the user equipment to present the target image on which the rendering is completed.

The apparatus provided in this embodiment may be used to perform the technical solutions of the foregoing method embodiments, and implementation principles and technical effects of the apparatus are similar, and are not repeatedly described herein in this embodiment.

In order to realize the above-described embodiments, the embodiments of the present disclosure further provide an electronic device.

Referring to FIG. 7, a schematic structural diagram of an electronic device 700 suitable for implementing an embodiment of the present disclosure is shown. The electronic device 700 may be a terminal device or a server. The terminal device may include, but is not limited to, a mobile terminal such as a mobile phone, a laptop computer, a digital broadcast receiver, a personal digital assistant (PDA), a portable android device (PAD), a portable multimedia player (PMP), a vehicle-mounted terminal (e. g., a vehicle-mounted navigation terminal), and the like, and a fixed terminal such as a digital TV, a desktop computer, and the like. The electronic device shown in FIG. 7 is merely an example and should not bring any limitation to the functions and scope of use of embodiments of the present disclosure.

As shown in FIG. 7, the electronic device 700 may include a processing apparatus (e. g., a central processing unit, a graphics processor, etc.) 701 that may perform various suitable actions and processes in accordance with a program stored in a read only memory (ROM) 702 or a program loaded into a random access memory (RAM) 703 from a storage apparatus 708. A variety of programs and data necessary for operations of the electronic device 700 are also stored in the RAM 703. The processing apparatus 701, the ROM 702, and the RAM 703 are connected to each other via a bus 704. An input/output (I/O) interface 705 is also connected to the bus 704.

In general, the following apparatuses may be connected to the I/O interface 705: an input apparatus 706 including, for example, a touch screen, a touch pad, a keyboard, a mouse, a camera, a microphone, an accelerometer, a gyroscope, or the like; an output apparatus 707 including, for example, a liquid crystal display (LCD), a speaker, a vibrator, or the like; the storage apparatus 708 including, for example, a magnetic tape, a hard disk, or the like; and a communication apparatus 709. The communication apparatus 709 can allow the electronic device 700 to communicate wirelessly or wirely with other apparatuses to exchange data. While FIG. 7 shows the electronic device 700 having various apparatuses, it is to be understood that not all of the shown apparatuses are required to be implemented or provided. More or fewer apparatuses may alternatively be implemented or provided.

In particular, the processes described above with reference to the flowcharts can be implemented as a computer software program in accordance with the embodiments of the present disclosure. For example, the embodiments of the present disclosure include a computer program product comprising a computer program carried on a computer-readable medium. The computer program comprises a program code for performing the method as shown in the flowcharts. In such an embodiment, the computer program may be downloaded and installed from a network through the communication apparatus 709, installed from the storage apparatus 708, or installed from the ROM 702. When the computer program is executed by the processing apparatus 701, the described functions defined in the method according to the embodiment of the present disclosure are performed.

It should be noted that the computer-readable medium described above in the present disclosure may be a computer-readable signal medium or a computer-readable storage medium, or any combination of both. The computer-readable storage medium may be, for example, but not limited to, an electronic, a magnetic, an optical, an electromagnetic, an infrared, or a semiconductor system, apparatus, or device, or any suitable combination of the foregoing. More specific examples of the computer-readable storage medium may include, but are not limited to, an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium that contains or stores a program for use by or in connection with an instruction execution system, apparatus, or device. While in the present disclosure, the computer-readable signal medium may include a propagated data signal with computer-readable program code embodied therein, for example, in baseband or as part of a carrier wave. Such a propagated signal may take any of a variety of forms, including, but not limited to, electro-magnetic signal, optical signal, or any suitable combination thereof. The computer-readable signal medium may also be any computer-readable medium other than a computer-readable storage medium that can communicate, propagate, or transport a program for use by or in connection with an instruction execution system, apparatus, or device. Program code embodied on the computer-readable medium may be transmitted using any appropriate medium, including, but not limited to, a wireline, an optical fiber cable, a radio frequency (RF), and the like, or any suitable combination of the foregoing.

The computer-readable medium described above may be included in the electronic device, or may exist separately and not be installed in the electronic device.

The computer-readable medium described above bears one or more programs, that when executed by the electronic device, cause the electronic device to execute the method shown in the foregoing embodiments.

Computer program code for carrying out operations of the present disclosure may be written in one or more programming languages or combination thereof, including object-oriented programming languages such as Java, Smalltalk, C++ or the like and conventional procedural programming languages, such as the “C” programming language or similar programming languages. The program code may be executed entirely on a user's computer, partly on a user's computer, as a stand-alone software package, partly on the user's computer and partly on a remote computer or entirely on the remote computer or server. In the latter situation, the remote computer may be connected to the user's computer through any type of network, including a local area network (LAN) or a wide area network (WAN), or the connection may be made to an external computer (for example, through the Internet using an Internet Service Provider).

The flowcharts and block diagrams in the Figures illustrate the architecture, functionality, and operation of possible implementations of systems, methods and computer program products according to various embodiments of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units involved in the embodiments of the present disclosure may be implemented through software or hardware. The name of a unit does not constitute a limitation to the unit itself in some cases. For example, the first acquisition unit may also be described as “unit to acquire at least two internet protocol addresses”.

The functions described above herein may be performed, at least in part, by one or more hardware logic components. For example, exemplary types of hardware logic components that can be used include, without limitation, Field Programmable Gate Arrays (FPGAs), Application Specific Integrated Circuit (ASICs), Application Specific Standard Products (ASSPs), System on Chip (SOCs), Complex Programmable Logic Devices (CPLDs), and so on.

In the context of this disclosure, a machine-readable medium may be tangible media that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of machine-readable storage media would include an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the foregoing.

In a first aspect, according to one or more embodiments of the present disclosure, there is provided a line effect processing method, comprising:
collecting a plurality of contour points formed by an object contour of a target object in an image to be processed;
performing point expansion processing on the plurality of contour points to obtain a plurality of vertices;
generating texture curves corresponding to adjacent pairs of vertices based on the plurality of vertices, and obtaining at least one texture curve;
utilizing the at least one texture curve to generate an effect line frame; and
mapping the effect line frame onto the image to be processed to obtain a target image corresponding to the image to be processed.

According to one or more embodiments of the present disclosure, the performing point expansion processing on the plurality of contour points to obtain a plurality of vertices comprises:
connecting two contour points satisfying adjacent conditions among the plurality of contour points to obtain at least one contour line segment;
determining, based on a line width, an expansion line segment corresponding to a contour line segment, to obtain expansion line segments corresponding to the at least one contour line segment;
determining, by utilizing the expansion line segments corresponding to the at least one contour line segment, that two end points of the expansion line segment are two expansion points, to obtain a plurality of expansion points formed by expansion points of the at least one expansion line segment; and
de-duplicating the plurality of contour points and the plurality of expansion points to obtain the plurality of vertices.

According to one or more embodiments of the present disclosure, the determining, based on a line width, an expansion line segment corresponding to a contour line segment comprises:
detecting whether two vertices corresponding to the contour line segment include a tail point;
making a vertical line perpendicular to the contour line segment to a non-tail point of the two vertices according to the line width in case that the tail point is included, and determining the other end point of the vertical line to be an expansion point corresponding to the contour line segment;
determining a line segment formed by connecting the expansion point with the tail point to be the expansion line segment corresponding to the contour line segment; and
making vertical lines perpendicular to the contour line segment according to the line width for two contour points of the contour line segment in case that no tail point is included, and determining a line segment formed by the other two end points corresponding to the two vertical lines to be the expansion line segment.

According to one or more embodiments of the present disclosure, the generating texture curves corresponding to adjacent pairs of vertices based on the plurality of vertices to obtain a plurality of texture curves comprises:
determining a plurality of line segments corresponding to the plurality of vertices;
calculating line segment intersections for any two line segments satisfying a condition of line segment intersection among the plurality of line segments, and obtaining intersections corresponding to at least one line segment group among the plurality of line segments;
performing, based on any line segment group, smooth processing on two line segments of the line segment group and intersections thereof, to obtain a smooth curve corresponding to the line segment group; and
performing line segment attribute setting on the smooth curves corresponding to the at least one line segment group, to obtain at least one texture curve of which the attribute setting ends.

According to one or more embodiments of the present disclosure, the performing line segment attribute setting on the smooth curves corresponding to the at least one line segment group, to obtain at least one texture curve of which the attribute setting ends comprises:
determining smooth curves corresponding to the at least one line segment group, to obtain at least one smooth curve;
sequentially setting a color attribute and/or a width attribute of the at least one smooth curve, and obtaining at least one texture curve of which the attribute setting ends.

According to one or more embodiments of the present disclosure, the utilizing the at least one texture curve to generate an effect line frame comprises:
mapping the at least one texture curve into a line frame model to obtain a curve line frame corresponding to the object contour; and
setting a rendering attribute for a line frame area corresponding to the curve line frame to obtain the effect line frame.

According to one or more embodiments of the present disclosure, the mapping the effect line frame onto the image to be processed to obtain a target image corresponding to the image to be processed comprises:
determining image positions corresponding to the plurality of contour points in the image to be processed;
determining line frame positions corresponding to the plurality of contour points in the effect line frame;
performing position matching on the line frame positions and the image positions corresponding to the plurality of contour points, to obtain a position matching relationship of the plurality of contour points; and
mapping the effect line frame onto the image to be processed based on the position matching relationship of the plurality of contour points, to obtain the target image corresponding to the image to be processed when the mapping of the effect line frame ends.

According to one or more embodiments of the present disclosure, after the obtaining the target image corresponding to the image to be processed when the mapping of the effect line frame ends, the method further comprises:
correcting a position of the effect line frame in the target image to obtain a corrected target image.

According to one or more embodiments of the present disclosure, before the collecting a plurality of contour points formed by an object contour of a target object in an image to be processed, the method further comprises:
receiving a line effect processing request sent by a user equipment for a target video in the process of playing the target video by the user equipment;
acquiring a time-stamp for initiating the line effect processing request, in response to the line effect processing request;
collecting, based on the time-stamp, a corresponding image to be processed from the target video according to a collection frequency;
mapping the effect line frame onto the image to be processed to obtain a target image corresponding to the image to be processed, and then further comprising:
when it is detected that the user equipment is playing the image to be processed, rendering the target image corresponding to the effect line frame according to the rendering attribute corresponding to the effect line frame; and
controlling the user equipment to present the target image on which the rendering is completed.

In a second aspect, according to one or more embodiments of the present disclosure, there is provided a line effect processing apparatus, comprising:
a contour collection unit for collecting a plurality of contour points formed by an object contour of a target object in an image to be processed;
a vertex expansion unit for performing point expansion processing on the plurality of contour points to obtain a plurality of vertices;
a curve generation unit for generating texture curves corresponding to adjacent pairs of vertices based on the plurality of vertices, and obtaining at least one texture curve;
an effect generation unit for utilizing the at least one texture curve to generate an effect line frame; and
a line mapping unit for mapping the effect line frame onto the image to be processed to obtain a target image corresponding to the image to be processed.

In a third aspect, according to one or more embodiments of the present disclosure, there is provided an electronic device, comprising:
at least one processor; and
a memory,
the memory stores computer executable instructions,
the at least one processor executes the computer executable instructions stored in the memory, so that the at least one processor executes the line feature processing method of the first aspect and various possible designs of the first aspect.

In a fourth aspect, according to one or more embodiments of the present disclosure, there is provided a computer-readable storage medium having stored therein computer executable instructions, that when executed by a processor, implement the line feature processing method of the first aspect and various possible designs of the first aspect.

In a fifth aspect, according to one or more embodiments of the present disclosure, there is provided a computer program product including a computer program, that when executed by a processor, implements the line effect processing method of the first aspect and various possible designs of the foregoing first aspect.

In a sixth aspect, an embodiment of the present disclosure provides a computer program, that when executed by a processor, implements the line feature processing method of the first aspect and various possible designs of the first aspect.

The above description is merely illustrative of the preferred embodiments of the present disclosure and of the technical principles applied thereto. As will be appreciated by those skilled in the art, the disclosure of the present disclosure is not limited to the technical solutions formed by the specific combination of the described technical features. Meanwhile, it should also cover other technical solutions formed by any combination of the described technical features or equivalent features thereof without departing from the described disclosed concept. For example, the above features and technical features having similar functions disclosed in the present disclosure (but not limited thereto) are replaced with each other to form a technical solution.

In addition, while operations are depicted in a particular order, this should not be understood as requiring the operations to be performed in the particular order shown or in sequential order. Multitasking and parallel processing may be advantageous in certain circumstances. Likewise, while several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1. A method of line effect processing, comprising:
collecting a plurality of contour points formed by an object contour of a target object in an image to be processed;
performing a point expansion processing on the plurality of contour points to obtain a plurality of vertices;
generating at least one texture curve based on adjacent pairs of vertices in the plurality of vertices;
generating an effect line frame with the at least one texture curve; and
mapping the effect line frame to the image to be processed, to obtain a target image corresponding to the image to be processed.

2. The method of claim 1, wherein, performing a point expansion processing on the plurality of contour points, and obtaining a plurality of vertices comprises:
connecting two contour points satisfying an adjacent condition among the plurality of contour points, to obtain at least one contour line segment;
determining an expansion line segment corresponding to the contour line segment based on a line width, to obtain an expansion line segment corresponding to the at least one contour line segment;
determining, using the expansion line segment corresponding to the at least one contour line segment, two end points of the expansion line segment as two expansion points to obtain a plurality of expansion points comprised of expansion points of the at least one expansion line segment; and
de-duplicating the plurality of contour points and the plurality of expansion points to obtain the plurality of vertices.

3. The method of claim 2, wherein, determining an expansion line segment corresponding to the contour line segment comprises:
detecting whether two vertices corresponding to the contour line segment comprise a tail point;
in response to a tail point being comprised, determining a vertical line perpendicular to the contour line segment on a non-tail point of the two vertices according to the line width, and determining the other end point of the vertical line as an expansion point corresponding to the contour line segment; determining a line segment formed by connecting the expansion point with the tail point as the expansion line segment corresponding to the contour line segment; and
in response to no tail point being comprised, determining a vertical line perpendicular to the contour line segment according to the line width for two contour points of the contour line segment, and determining a line segment formed by other two end points corresponding to the two vertical lines as the expansion line segment.

4. The method of claim 1, wherein, generating at least one texture curve based on adjacent pairs of vertices among the plurality of vertices comprises:
determining a plurality of line segments corresponding to the plurality of vertices;
performing line segment intersection calculation on any two line segments satisfying a condition of line segment intersection among the plurality of line segments, and obtaining an intersection corresponding to at least one set of line segments among the plurality of line segments;
for any set of line segments, performing an intersection smoothing processing on two line segments of the set of line segments and an intersection of the two line segments, and obtaining a smooth curve corresponding to the set of line segments; and
performing a line segment attribute configuration on the smooth curve of the set of line segments to obtain respective texture curves of the at least one set of line segments after the attribute configuration ends.

5. The method of claim 4, wherein, performing a line segment attribute configuration on the smooth curve of the set of line segments to obtain the respective texture curves of the at least one set of line segments after the attribute configuration ends comprises:
performing a color attribute and/or a width attribute configuration on the smooth curve of the set of line segments, and obtaining the respective texture curves of the at least one set of line segments after the attribute configuration ends.

6. The method of claim 1, wherein, generating the effect line frame with the at least one texture curve comprises:
mapping the at least one texture curve to a line frame model, to obtain a curve line frame corresponding to the object contour; and
setting a rendering attribute for a line frame area corresponding to the curve line frame, to obtain the effect line frame.

7. The method of claim 1, wherein, mapping the effect line frame to the image to be processed, to obtain a target image corresponding to the image to be processed comprises:
determining image positions corresponding to the plurality of contour points in the image to be processed;
determining line frame positions corresponding to the plurality of contour points in the effect line frame;
performing position matching between the line frame positions and the image positions corresponding to the plurality of contour points, to obtain a position matching relationship of the plurality of contour points; and
mapping the effect line frame to the image to be processed based on the position matching relationship of the plurality of contour points, to obtain the target image corresponding to the image to be processed in response to an end of a mapping of the effect line frame.

8. The method of claim 7, wherein, after obtaining the target image corresponding to the image to be processed in response to an endo of the mapping of the effect line frame, the method further comprises:
performing a position correction processing on the effect line frame in the target image, to obtain a corrected target image.

9. The method of claim 1, wherein, before collecting a plurality of contour points formed by an object contour of a target object in an image to be processed, the method further comprises:
receiving a line effect processing request sent by a user device for a target video during a process of playing a target video by the user device;
in response to the line effect processing request, obtaining a time-stamp initiating the line effect processing request; and
collecting, based on the time-stamp, a corresponding image to be processed from the target video according to a collection frequency,
mapping the effect line frame to the image to be processed to obtain a target image corresponding to the image to be processed further comprises:
in response to detecting that the user device is playing the image to be processed, rendering the target image corresponding to the effect line frame according to a rendering attribute corresponding to the effect line frame; and
controlling the user device to present the rendered target image.

10. (canceled)

11. An electronic device, comprising:
a processor; and
a memory;
the memory stores computer executable instructions, and
the processor executes the computer executable instructions stored in the memory, so that the processor is configured with the line effect processing method comprising:
collecting a plurality of contour points formed by an object contour of a target object in an image to be processed;
performing a point expansion processing on the plurality of contour points to obtain a plurality of vertices;
generating at least one texture curve based on adjacent pairs of vertices in the plurality of vertices;
generating an effect line frame with the at least one texture curve; and
mapping the effect line frame to the image to be processed, to obtain a target image corresponding to the image to be processed.

12. A non-transitory computer-readable storage medium having stored therein computer executable instructions, that when executed by a processor, implement the line effect processing method comprising:
collecting a plurality of contour points formed by an object contour of a target object in an image to be processed;
performing a point expansion processing on the plurality of contour points to obtain a plurality of vertices;
generating at least one texture curve based on adjacent pairs of vertices in the plurality of vertices;
generating an effect line frame with the at least one texture curve; and
mapping the effect line frame to the image to be processed, to obtain a target image corresponding to the image to be processed.

13. (canceled)

14. (canceled)

15. The electronic device of claim 11, wherein, performing a point expansion processing on the plurality of contour points, and obtaining a plurality of vertices comprises:
connecting two contour points satisfying an adjacent condition among the plurality of contour points, to obtain at least one contour line segment;
determining an expansion line segment corresponding to the contour line segment based on a line width, to obtain an expansion line segment corresponding to the at least one contour line segment;
determining, using the expansion line segment corresponding to the at least one contour line segment, two end points of the expansion line segment as two expansion points to obtain a plurality of expansion points comprised of expansion points of the at least one expansion line segment; and
de-duplicating the plurality of contour points and the plurality of expansion points to obtain the plurality of vertices.

16. The electronic device of claim 15, wherein, determining an expansion line segment corresponding to the contour line segment comprises:
detecting whether two vertices corresponding to the contour line segment comprise a tail point;
in response to a tail point being comprised, determining a vertical line perpendicular to the contour line segment on a non-tail point of the two vertices according to the line width, and determining the other end point of the vertical line as an expansion point corresponding to the contour line segment; determining a line segment formed by connecting the expansion point with the tail point as the expansion line segment corresponding to the contour line segment; and
in response to no tail point being comprised, determining a vertical line perpendicular to the contour line segment according to the line width for two contour points of the contour line segment, and determining a line segment formed by other two end points corresponding to the two vertical lines as the expansion line segment.

17. The electronic device of claim 11, wherein, generating at least one texture curve based on adjacent pairs of vertices among the plurality of vertices comprises:
determining a plurality of line segments corresponding to the plurality of vertices;
performing line segment intersection calculation on any two line segments satisfying a condition of line segment intersection among the plurality of line segments, and obtaining an intersection corresponding to at least one set of line segments among the plurality of line segments;
for any set of line segments, performing a intersection smoothing processing on two line segments of the set of line segments and an intersection of the two line segments, and obtaining a smooth curve corresponding to the set of line segments; and
performing a line segment attribute configuration on the smooth curve of the set of line segments to obtain respective texture curves of the at least one set of line segments after the attribute configuration ends.

18. The electronic device of claim 17, wherein, performing a line segment attribute configuration on the smooth curve of the set of line segments to obtain the respective texture curves of the at least one set of line segments after the attribute configuration ends comprises:
performing a color attribute and/or a width attribute configuration on the smooth curve of the set of line segments, and obtaining the respective texture curves of the at least one set of line segments after the attribute configuration ends.

19. The electronic device of claim 11, wherein, generating the effect line frame with the at least one texture curve comprises:
mapping the at least one texture curve to a line frame model, to obtain a curve line frame corresponding to the object contour; and
setting a rendering attribute for a line frame area corresponding to the curve line frame, to obtain the effect line frame.

20. The electronic device of claim 11, wherein, mapping the effect line frame to the image to be processed, to obtain a target image corresponding to the image to be processed comprises:
determining image positions corresponding to the plurality of contour points in the image to be processed;
determining line frame positions corresponding to the plurality of contour points in the effect line frame;
performing position matching between the line frame positions and the image positions corresponding to the plurality of contour points, to obtain a position matching relationship of the plurality of contour points; and
mapping the effect line frame to the image to be processed based on the position matching relationship of the plurality of contour points, to obtain the target image corresponding to the image to be processed in response to an end of a mapping of the effect line frame.

21. The electronic device of claim 20, wherein, after obtaining the target image corresponding to the image to be processed in response to an endo of the mapping of the effect line frame, the method further comprises:
performing a position correction processing on the effect line frame in the target image, to obtain a corrected target image.

22. The electronic device of claim 11, wherein, before collecting a plurality of contour points formed by an object contour of a target object in an image to be processed, the method further comprises:
receiving a line effect processing request sent by a user device for a target video during a process of playing a target video by the user device;
in response to the line effect processing request, obtaining a time-stamp initiating the line effect processing request; and
collecting, based on the time-stamp, a corresponding image to be processed from the target video according to a collection frequency,
mapping the effect line frame to the image to be processed to obtain a target image corresponding to the image to be processed further comprises:
in response to detecting that the user device is playing the image to be processed, rendering the target image corresponding to the effect line frame according to a rendering attribute corresponding to the effect line frame; and
controlling the user device to present the rendered target image.

23. The non-transitory computer-readable storage medium of claim 12, wherein, performing a point expansion processing on the plurality of contour points, and obtaining a plurality of vertices comprises:
connecting two contour points satisfying an adjacent condition among the plurality of contour points, to obtain at least one contour line segment;
determining an expansion line segment corresponding to the contour line segment based on a line width, to obtain an expansion line segment corresponding to the at least one contour line segment;
determining, using the expansion line segment corresponding to the at least one contour line segment, two end points of the expansion line segment as two expansion points to obtain a plurality of expansion points comprised of expansion points of the at least one expansion line segment; and
de-duplicating the plurality of contour points and the plurality of expansion points to obtain the plurality of vertices.
